(19) United States
(12) Patent Application Publication
(10) Pub. No.: US 2004/0067813 A1
(43) Pub. Date: Apr. 8, 2004

(54) Rotatory transmitting mechanism, machine tool with the mechanism, and tool holder

(76) Inventor: Tsuyoshi Komine, Hyogo (JP)

Correspondence Address: WOLF GREENFIELD & SACKS, PC, FEDERAL RESERVE PLAZA, 600 ATLANTIC AVENUE, BOSTON, MA, 02210-2211, US

(21) Appl. No.: 10/425,392

(22) Filed: Apr. 29, 2003

(30) Foreign Application Priority Data
Oct. 4, 2002 (JP) 2002-292199

(51) Int. Cl. F16H 48/06

(52) U.S. Cl. 475/230

(57) ABSTRACT

The present invention provides a rotatory transmitting mechanism that is capable of decreasing the load imposed at the time of transmission of a rotatory motion without increasing the size of the rotatory transmitting mechanism, and is also capable of extending the life of bearings that support the shafts. This invention also provides a machine tool equipped with this rotatory transmitting mechanism, and further provides a tool holder. The rotatory transmitting mechanism comprises an input shaft 11 and an output shaft 12, whose shaft center O₂ intersects with the shaft center O₁ of the input shaft 11, and to which a rotatory motion from the input shaft 11 is transmitted. The rotatory transmitting mechanism is equipped with transmitting parts at symmetrical positions with respect to at least one of the shaft centers of the shafts.

### BACKGROUND

The present invention relates to a rotatory transmitting mechanism for transmitting a rotatory motion between two shafts, whose shaft centers intersect with each other. This invention also relates to a machine tool equipped with this rotatory transmitting mechanism, and further relates to a tool holder mounted to the machine tool.

For a conventional rotatory transmitting mechanism comprising an input shaft and an output shaft, whose shaft center intersects with the shaft center of the input shaft, a pair of bevel gears that engages with each other, and a rotatory transmitting mechanism that uses friction force, have been generally employed in order to transmit a rotatory motion from the input shaft to the output shaft.

For example, Japanese Utility Model Laid-Open (Kokai) Publication No. SH063-154860 discloses a backlash eliminator for bevel gears. Concerning this backlash eliminator, the above-mentioned publication discloses a rotatory transmitting mechanism which comprises: a pair of bevel gears that engages with each other and transmits power intermittently; a cam member that rotates with one of the bevel gears; and a cam follower which rotates with the other bevel gear, and the locus of which partly overlaps the locus of the cam member. This rotatory transmitting mechanism is constructed in such a manner that a cam groove, which allows the cam follower to pass, is formed in the cam member along the locus of the cam follower, and the cam follower and the cam groove are caused to tightly engage with each other at a rotation stop position of the bevel gears in order to prevent improper rotations due to backlashes of the pair of bevel gears.

Moreover, Japanese Utility Model Laid-Open (Kokai) Publication No. HEI 6-49263 discloses a bevel gear device that is capable of diminishing transmission of vibrations from wheels to a steering wheel and reducing backlashes at a contact of a pair of bevel gears so as to eliminate staggering of the steering wheel. The bevel gear device also eliminates the need for adjustment over a long period of time by compensating for friction even if such friction occurs on pressured surfaces. This bevel gear device comprises: a first bevel gear situated at one end of the input shaft, the other end of which is connected to the steering wheel; a second bevel gear which engages with the first bevel gear and is located at one end of the output shaft, whose shaft center intersects with the shaft center of the input shaft, wherein the other end of the output shaft is connected to a wheel steering device; a housing for receiving the first and second bevel gears and for supporting, with bearings, the input shaft and the output shaft so that they can freely rotate; a pressure object made by embedding an elastic member in a hollow part of a hollow member having two sliding surfaces that are respectively in contact with the end faces of the first and second bevel gears on their small-diameter sides, wherein the end faces respectively extend in the direction to intersect with each other; and a pressure applying element which is located between the elastic member of the pressure object and the housing, and which applies a force, via the two sliding surfaces, onto the end surfaces of the first and second bevel gears on their small-diameter sides.

However, when the rotatory motion is transmitted between the two shafts, whose shaft centers intersect with each other, the above-described conventional types of rotatory transmitting mechanism and bevel gear device become subject to load applied in the vertical and horizontal directions relative to the respective shafts.

In order to bear the load, for example, double-row angular bearings or the like are used to support the respective shafts. However, when large power or intermittent power is to be transmitted, a problem of shortened life of the bearings arises.

And, if bearings with a high load capacity are used in order to extend the life of the bearings, a problem of the need to increase the size of the rotatory transmitting mechanism presents itself.

### SUMMARY

The present invention aims to solve the conventional problems discussed above. It is the object of this invention to provide a rotatory transmitting mechanism that is capable of reducing the load applied at the time of transmission of a rotatory motion without increasing the size of the rotatory transmitting mechanism, and that is also capable of extending the life of bearings that support shafts, and to provide a machine tool equipped with this rotatory transmitting mechanism, and to further provide a tool holder.

In order to achieve this object, this invention provides a rotatory transmitting mechanism for transmitting a rotatory motion between two shafts, whose shaft centers intersect with each other, wherein transmitting parts are located at symmetrical positions with respect to at least one of the shaft centers of the shafts.

Since the rotatory transmitting mechanism having this construction includes the transmitting parts located at the symmetrical positions with respect to at least one of the shaft centers of the shafts, it is possible to bear, at two positions at least, the load applied at the time of transmission of the rotatory motion. Accordingly, it is possible to reduce the load on the bearings that support the shaft, without the need to increase the size of the rotatory transmitting mechanism, thereby extending the life of the bearings.

The transmitting parts located at the symmetrical positions can be in the same configuration, respectively.

The rotatory transmitting mechanism according to this invention can be constructed in such a manner that it includes an input shaft and an output shaft, whose shaft center intersects with the shaft center of the input shaft, and to which a rotatory motion from the input shaft is transmitted, wherein the transmitting part located on the side of the shaft center of the input shaft opposite the output shaft side is mounted in a rotatable manner to a third shaft.

The rotatory transmitting mechanism having the above-described construction can use the transmitting part located on the output shaft itself and the transmitting part located on the third shaft, to bear the load applied at the time of transmission of the rotatory motion. Accordingly, it is possible to reduce the load on the bearings that support the shaft.

Moreover, the rotatory transmitting mechanism according to this invention can be constructed in such a manner that the transmitting part located on the side of the shaft center of the input shaft opposite the output shaft side is mounted in a rotatable manner to a third shaft, and the transmitting part located on the side of the shaft center of the output shaft opposite the input shaft side is mounted in a rotatable manner to a fourth shaft.

The rotatory transmitting mechanism having the above-described construction can use the transmitting part located on the output shaft itself, the transmitting part located on the third shaft, and the transmitting part located on the fourth shaft, to bear the load applied at the time of transmission of the rotatory motion. Accordingly, it is possible to further reduce the load on the bearings that support the shaft.

The rotatory transmitting mechanism according to this invention can be constructed in such a manner that it includes an input shaft and an output shaft, whose shaft center intersects with the shaft center of the input shaft, and to which a rotatory motion from the input shaft is transmitted, wherein the transmitting part located on the side of the shaft center of the output shaft opposite the input shaft side is mounted in a rotatable manner to a fourth shaft.

The rotatory transmitting mechanism having the above-described construction can use the transmitting part located on the output shaft itself and the transmitting part located on the fourth shaft, to bear the load applied at the time of transmission of the rotatory motion. Accordingly, it is possible to reduce the load on the bearings that support the shaft.

Furthermore, the rotatory transmitting mechanism according to this invention can be constructed in such a manner that it includes an input shaft and an output shaft, whose shaft center intersects with the shaft center of the input shaft, and to which a rotatory motion from the input shaft is transmitted, wherein one of the transmitting parts located at symmetrical positions with respect to the shaft center of the output shaft is located at one end of the input shaft, while the other transmitting part is located at a position closer to the other end of the input shaft and apart from the former transmitting part.

Since the rotatory transmitting mechanism having the above-described construction has at least two transmitting parts mounted to the input shaft, in addition to the aforementioned advantageous effect, it is possible to prevent the off-center displacement of the shaft.

Moreover, the rotatory transmitting mechanism according to this invention can be constructed in such a manner that it includes an input shaft and an output shaft, whose shaft center intersects with the shaft center of the input shaft, and to which a rotatory motion from the input shaft is transmitted, wherein one of the transmitting parts located at symmetrical positions with respect to the shaft center of the input shaft is located at one end of the output shaft, while the other transmitting part is located at a position closer to the other end of the output shaft and apart from the former transmitting part.

Since the rotatory transmitting mechanism having the above-described construction has two transmitting parts mounted to the output shaft, in addition to the aforementioned advantageous effect, it is possible to prevent the off-center displacement of the shaft.

Furthermore, the rotatory transmitting mechanism according to this invention can be constructed in such a manner that it includes an input shaft and an output shaft, whose shaft center intersects with the shaft center of the input shaft, and to which a rotatory motion from the input shaft is transmitted, wherein one of the transmitting parts located at symmetrical positions with respect to the shaft center of the input shaft is located at one end of the output shaft, while the other transmitting part is located at a position closer to the other end of the output shaft and apart from the former transmitting part, and wherein the transmitting part located on the side of the shaft center of the output shaft opposite the input shaft side is mounted in a rotatable manner to a fourth shaft.

Since the rotatory transmitting mechanism having the above-described construction has two transmitting parts mounted to the output shaft, in addition to the aforementioned advantageous effect, it is possible to prevent the off-center displacement of the shaft. It is also possible to use the transmitting part mounted to the fourth shaft to bear the load applied at the time of transmission of the rotatory motion. Accordingly, it is possible to further reduce the load on the bearings that support the shaft.

The transmitting parts can include a pair of gears that engages with each other. The transmitting parts may be constructed so as to transmit the rotatory motion by means of friction. Moreover, the two shafts can perpendicularly intersect with each other.

The transmitting parts can be supported by the bearings that regulate the positions of the transmitting parts in the thrust direction and in the radial direction. This construction can further enhance the positioning accuracy of the transmitting parts.

This invention also provides a machine tool equipped with the above-described rotatory transmitting mechanism. When the rotatory motion is transmitted between the two shafts, whose shaft centers intersect with each other, it is possible to bear, at two positions at least, the load applied at the time of transmission of the rotatory motion. Accordingly, it is possible to reduce the load on the bearings that support the shaft, thereby extending the life of the bearings.

Moreover, this invention provides a tool holder comprising: the above-described rotatory transmitting mechanism; and a holder body with its one end connected to one end of the rotatory transmitting mechanism, and with the other end including a holding part for holding a tool.

Furthermore, this invention provides a tool holder with its one end having a connection part connected to the machine tool of this invention, and with the other end including a holding part for holding a tool.

### DESCRIPTION OF THE DRAWINGS

FIG. 1 is a sectional view of a part of the machine tool equipped with the rotatory transmitting mechanism according to Embodiment 1.

FIG. 2 illustrates the state of application of load to the rotatory transmitting mechanism shown in FIG. 1.

FIG. 3 is a sectional view of a part of the machine tool equipped with the rotatory transmitting mechanism according to Embodiment 2.

FIG. 4 illustrates the state of application of load to the rotatory transmitting mechanism shown in FIG. 3.

FIG. 5 is a sectional view of a part of the machine tool equipped with the rotatory transmitting mechanism according to Embodiment 3.

FIG. 6 illustrates the state of application of load to the rotatory transmitting mechanism shown in FIG. 5.

FIG. 7 is a sectional view of a part of the machine tool equipped with the rotatory transmitting mechanism according to Embodiment 4.

FIG. 8 is a sectional view of a part of the machine tool equipped with the rotatory transmitting mechanism according to Embodiment 5.

### DETAILED DESCRIPTION

Preferred embodiments of the rotatory transmitting mechanism according to this invention are explained below with reference to the attached drawings. Embodiments 1 through 5 are described below for purposes of illustration of this invention, and this invention is not limited to these embodiments. The invention can be implemented in various manners unless such variations depart from the gist of the invention.

(Embodiment 1)

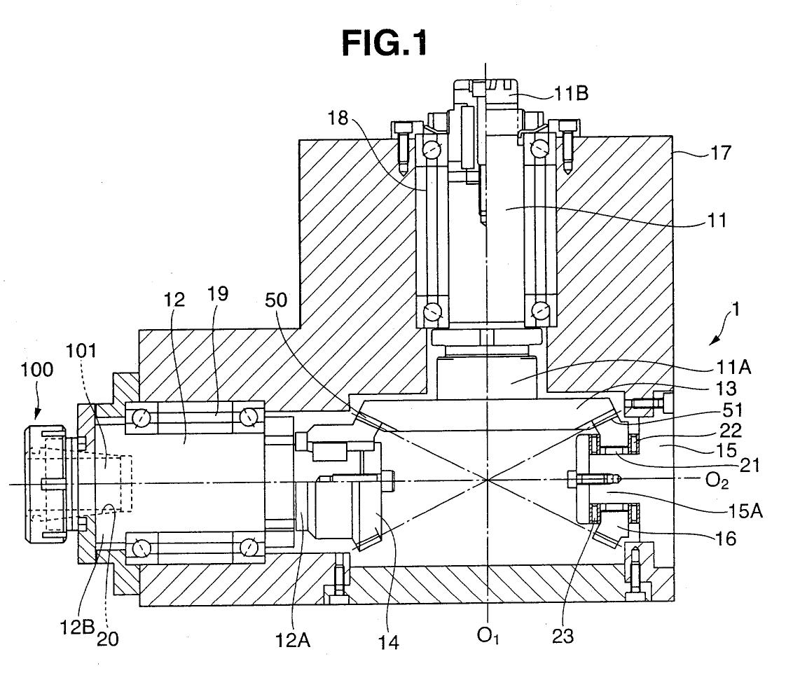

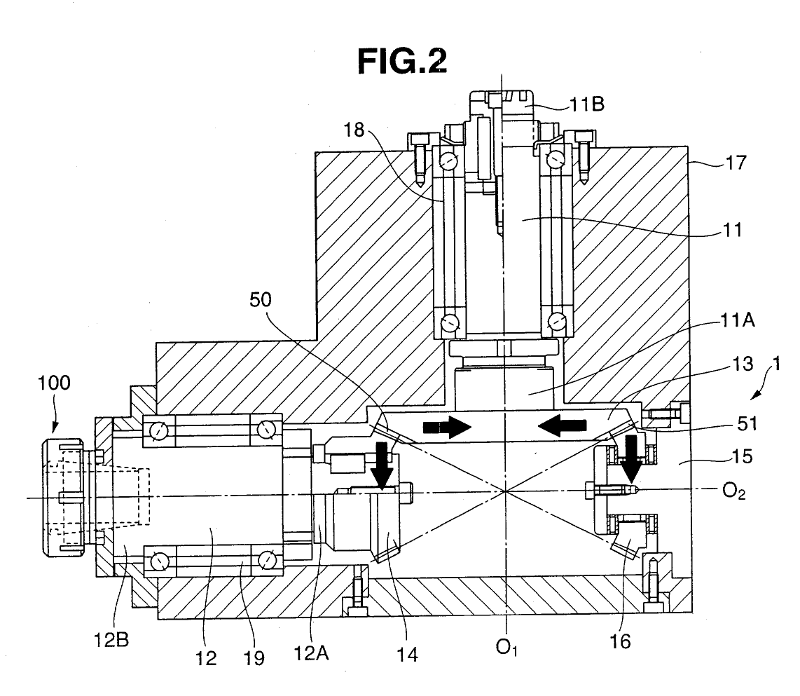

FIG. 1 is a sectional view of a part of a machine tool equipped with a rotatory transmitting mechanism according to Embodiment 1. FIG. 2 illustrates the state of application of load to the rotatory transmitting mechanism shown in FIG. 1. In FIG. 2, reference numerals are given only to the main parts in order to clearly show the state of application of load.

As shown in FIG. 1, a rotatory transmitting mechanism 1 of Embodiment 1 includes an input shaft 11 which transmits a rotatory motion, and an output shaft 12, whose shaft center O₂ intersects perpendicularly with the shaft center O₁ of the input shaft 11, and into which the rotatory motion of the input shaft 11 is transmitted, thereby causing the output shaft 12 to rotate. The rotatory transmitting mechanism 1 also includes transmitting parts 50 and 51 located at symmetrical positions with respect to the shaft center O₁ of the input shaft 11.

The input shaft 11 is positioned in a rotatable manner in a housing 17 through a bearing 18. At one end 11A of the input shaft 11, a first bevel gear 13 is positioned so that it can rotate with input shaft 11. A rotatory drive unit not shown in the drawings is connected to the other end 11B of input shaft 11.

The output shaft 12 is positioned in a rotatable manner in the housing 17 through a bearing 19. At one end 12A of the output shaft 12, a second bevel gear 14, which engages and rotates with the first bevel gear 13, is positioned so that the second bevel gear 14 can rotate with output shaft 12. At the other end 12B of the output shaft 12, a taper hole 20 is formed in which a connection part 101 of a tool holder 100 is mounted.

A third shaft 15 is located on the side of the shaft center O₁ of the input shaft 11 opposite the output shaft 12 side. This third shaft 15 is firmly attached to the housing 17. At one end 15A of the third shaft 15, a third bevel gear 16 that engages with the first bevel gear 13 is positioned in a rotatable manner through bearings 21, 22, and 23. An example of the bearing 21 includes a needle bearing, and the bearing 21 regulates the position of the third bevel gear 16 in the radial direction. Examples of the bearings 22 and 23 include thrust bearings, and the bearings 22 and 23 regulate the position of the third bevel gear 16 in the thrust direction.

The transmitting part 50 includes a contact where the first bevel gear 13 engages with the second bevel gear 14. The transmitting part 51 includes a contact where the first bevel gear 13 engages with the third bevel gear 16. In other words, in the rotatory transmitting mechanism 1, the transmitting parts 50 and 51 are located at symmetrical positions with respect to the shaft center O₁ of the input shaft 11. Since the second bevel gear 14 and the third bevel gear 16 are located at symmetrical positions with respect to the shaft center O₁ of the input shaft 11, the 180° phase shifted portions of the first bevel gear 13 are supported by the second bevel gear 14 and the third bevel gear 16. Accordingly, it is possible to bear, at two positions that are at the transmitting parts 50 and 51, the load applied at the time of transmission of the rotatory motion. Therefore, it is possible to reduce the load on the bearings 18 and 19 that support the input shaft 11 and the output shaft 12, thereby extending the life of the bearings 18 and 19.

An explanation is given below about the specific working of a machine tool equipped with the rotatory transmitting mechanism 1 according to Embodiment 1.

In order to transmit the rotatory motion from the input shaft 11 to output shaft 12, the rotatory drive unit (not shown in the drawings) is first activated to rotate the input shaft 11 at a desired rotating speed. This rotation of the input shaft 11 causes the first bevel gear 13 to rotate. The second bevel gear 14 and the third bevel gear 16 then engage and rotate with the first bevel gear 13. This results in transmitting the rotatory motion of the input shaft 11 to the second bevel gear 14 and the third bevel gear 16. This action causes the rotatory motion from the input shaft 11 to be transmitted through the second bevel gear 14 to the output shaft 12, thereby causing output shaft 12 to rotate.

As described above, since the first bevel gear 13 is supported by the second bevel gear 14 located on-the output shaft 12, and by the third bevel gear 16 located on the third shaft 15, the load is distributed as indicated by arrows in FIG. 2 at the time of transmission of the rotatory motion. In other words, since the rotatory transmitting mechanism 1 bears the load applied at the time of transmission of the rotatory motion, at two positions that are at the transmitting parts 50 and 51, it is possible to reduce the load on the bearings 18 and 19 that support the input shaft 11 and the output shaft 12. Moreover, since the third bevel gear 16 is located through the bearings 21, 22, and 23, the positioning of the third bevel gear 16 in the thrust direction and the radial direction can be conducted accurately and securely.

The rotation of output shaft 12 causes the tool holder 100 to rotate, thereby enabling a tool (not shown in the drawings) mounted at the top of the tool holder 100 to perform the processing of a work piece.

(Embodiment 2)

A rotatory transmitting mechanism according to Embodiment 2 of this invention is described below with reference to the relevant drawings.

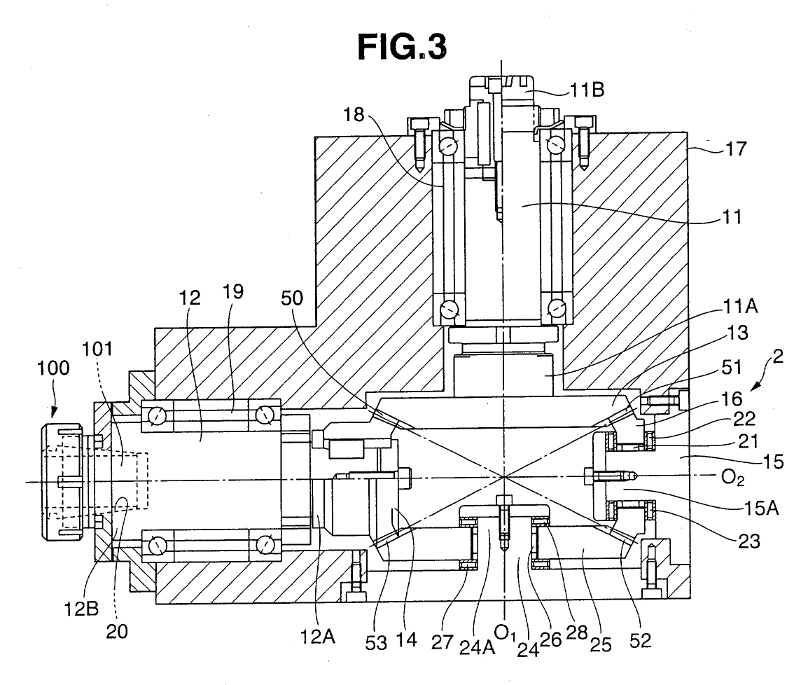

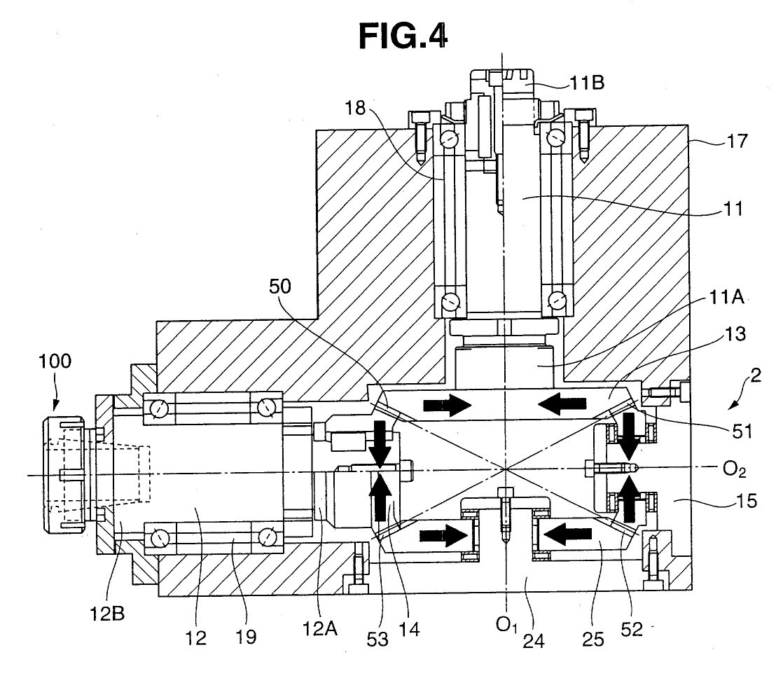

FIG. 3 is a sectional view of a part of a machine tool equipped with a rotatory transmitting mechanism according to Embodiment 2. FIG. 4 illustrates the state of application of load to the rotatory transmitting mechanism shown in FIG. 3. In FIG. 4, reference numerals are given only to the main parts in order to clearly show the state of application of load. For Embodiment 2, elements similar to those described in Embodiment 1 are given the same reference numerals as in Embodiment 1, and any detailed explanation of such elements is omitted here.

As shown in FIG. 3, the main difference between a rotatory transmitting mechanism 2 of Embodiment 2 and the rotatory transmitting mechanism 1 of Embodiment 1 is that, in addition to the construction of the rotatory transmitting mechanism 1, a fourth shaft 24 is located on the side of the shaft center O₂ of the output shaft 12 opposite the input shaft 11 side, and a fourth bevel gear 25 is positioned in a rotatable manner on the fourth shaft 24. In other words, the main difference is that transmitting parts 52 and 53, which are located at symmetrically opposed positions, are additionally included in Embodiment 2.

The fourth shaft 24 is located on the side of the shaft center O₂ of the output shaft 12 opposite the input shaft 11 side. This fourth shaft 24 is firmly attached to the housing 17. At one end 24A of the fourth shaft 24, the fourth bevel gear 25, which engages with the second bevel gear 14 and the third bevel gear 16, is positioned in a rotatable manner through bearings 26, 27, and 28. An example of the bearing 26 includes a needle bearing, and the bearing 26 regulates the position of the fourth bevel gear 25 in the radial direction. Examples of the bearings 27 and 28 include thrust bearings, and the bearings 27 and 28 regulate the position of the fourth bevel gear 25 in the thrust direction.

The transmitting part 52 includes a contact where the third bevel gear 16 engages with the fourth bevel gear 25. The transmitting part 53 includes a contact where the second bevel gear 14 engages with the fourth bevel gear 25. The first bevel gear 13 and the fourth bevel gear 25 are located at symmetrical positions with respect to the shaft center O₂ of the output shaft 12. In other words, in the rotatory transmitting mechanism 2, the transmitting parts 50 and 51 are located at symmetrical positions and the transmitting parts 53 and 52 are located at symmetrical positions with respect to the shaft center O₁ of the input shaft 11, and the transmitting parts 50 and 53 are located at symmetrical positions and the transmitting parts 51 and 52 are located at symmetrical positions with respect to the shaft center O₂ of the output shaft 12.

Concerning the rotatory transmitting mechanism 2 having the above-described construction, the 180° phase shifted portions of the first bevel gear 13 are supported by the second bevel gear 14 and the third bevel gear 16. Moreover, the second bevel gear 14 and the third bevel gear 16 are supported by the fourth bevel gear 25. Accordingly, it is possible to bear, at the transmitting parts 50, 51, 52, and 53, the load applied at the time of transmission of the rotatory motion. Therefore, it is possible to reduce the load on the bearings 18 and 19 for supporting the input shaft 11 and the output shaft 12, thereby extending the life of the bearings 18 and 19.

An explanation is given below about the specific working of a machine tool equipped with the rotatory transmitting mechanism 2 according to Embodiment 2.

In order to transmit the rotatory motion of the input shaft 11 to the output shaft 12, as with Embodiment 1, the rotatory drive unit (not shown in the drawings) is first activated to rotate the input shaft 11 at a desired rotating speed. This rotation of the input shaft 11 causes the first bevel gear 13 to rotate. The second bevel gear 14 and the third bevel gear 16 then engage and rotate with the first bevel gear 13. This results in transmitting the rotatory motion of the input shaft 11 to the second bevel gear 14 and the third bevel gear 16. This action causes the rotatory motion of the input shaft 11 to be transmitted through the second bevel gear 14 to the output shaft 12, thereby causing output shaft 12 to rotate. Simultaneously, both the second bevel gear 14 and the third bevel gear 16 engage with the fourth bevel gear 25, thereby causing the fourth bevel gear 25 to rotate.

As described above, since the transmitting parts 50, 51, 52, and 53 bear the load generated at the time of transmission of the rotatory motion from the input shaft 11 to the output shaft 12, the load is distributed as indicated by arrows in FIG. 4 at the time of transmission of the rotatory motion. Accordingly, it is possible to reduce the load on the bearings 18 and 19 that support the input shaft 11 and the output shaft 12. Moreover, since the third bevel gear 16 is positioned through the bearings 21, 22, and 23, the positioning of the third bevel gear 16 in the thrust direction and the radial direction can be conducted accurately and securely. Furthermore, since the fourth bevel gear 25 is located through the bearings 26, 27, and 28, the positioning of the fourth bevel gear 25 in the thrust direction and the radial direction can be conducted accurately and securely.

The rotation of the output shaft 12 causes the tool holder 100 to rotate, thereby enabling a tool (not shown in the drawings) mounted at the top of the tool holder 100 to perform the processing of a work piece.

A possible construction as another embodiment may be realized by removing the third shaft 15, the third bevel gear 16, and the bearings 22, 23, and 24 from the construction of the rotatory transmitting mechanism 2. In this case, the transmitting parts 50 and 53 are located at symmetrical positions with respect to the shaft center O₂ of the output shaft 12. Since the first bevel gear 13 and the fourth bevel gear 25 are located at symmetrical positions with respect to the shaft center O₂ of the output shaft 12, the first bevel gear 13 is supported by the second bevel gear 14, and the second bevel gear 14 is supported by the fourth bevel gear 25. Accordingly, it is possible to bear, at two positions that are at transmitting parts 50 and 53, the load applied at the time of transmission of the rotatory motion.

(Embodiment 3)

A rotatory transmitting mechanism according to Embodiment 3 of this invention is described below with reference to the relevant drawings.

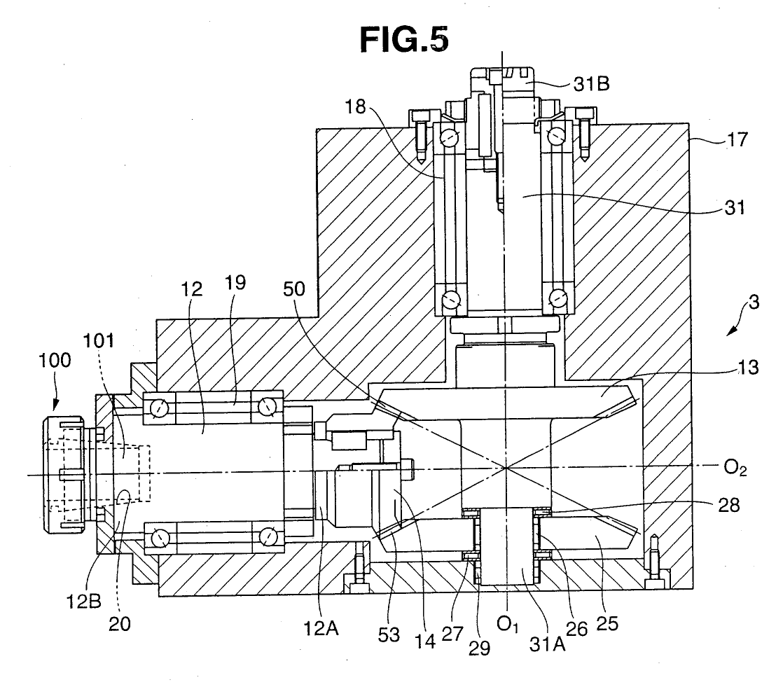

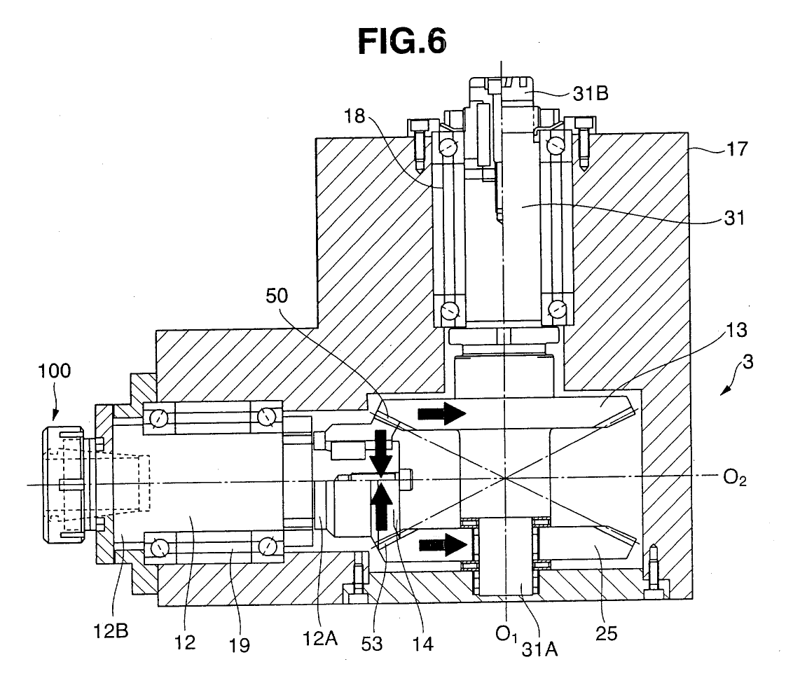

FIG. 5 is a sectional view of a part of a machine tool equipped with a rotatory transmitting mechanism according to Embodiment 3. FIG. 6 illustrates the state of application of load to the rotatory transmitting mechanism shown in FIG. 5. In FIG. 6, reference numerals are given only to the main parts in order to clearly show the state of application of load. Concerning Embodiment 3, elements similar to those described in Embodiments 1 and 2 are given the same reference numerals as in Embodiments 1 and 2, and any detailed explanation of such elements is omitted here.

As shown in FIG. 5, the main difference between a rotatory transmitting mechanism 3 of Embodiment 3 and the rotatory transmitting mechanism 1 of Embodiment 1 is that, without providing the third shaft 15 and the third bevel gear 16, an input shaft 31 extends beyond the first bevel gear 13, and the fourth bevel gear 25 is positioned in a rotatable manner at the end 31A of the input shaft 31.

The input shaft 31 is mounted in a rotatable manner in the housing 17 through bearing 18. At one end 31A of the input shaft 31, the fourth bevel gear 25 is mounted in a rotatable manner through bearings 26, 27, 28, and 29. An example of the bearing 29 includes a needle bearing, and the bearings 26 and 29 regulate the position of the fourth bevel gear 25 in the radial direction. At a position closer to the other end 31B of the input shaft 31 and apart from the end 31A, the first bevel gear 13 is positioned in such a manner that it can rotate with the input shaft 31. Moreover, a rotatory drive unit not shown in the drawings is connected to the other end 31B of the input shaft 31.

In the rotatory transmitting mechanism 3 having the above-described construction, transmitting parts 50 and 53 are located at symmetrical positions with respect to the shaft center O₂ of output shaft 12. Since the first bevel gear 13 and the fourth bevel gear 25 are located at symmetrical positions with respect to the shaft center O₂ of the output shaft 12, the first bevel gear 13 is supported by the second bevel gear 14, and the second bevel gear 14 is supported by the fourth bevel gear 25. Accordingly, it is possible to bear, at two positions that are at the transmitting parts 50 and 53, the load applied at the time of transmission of the rotatory motion. Therefore, it is possible to reduce the load on the bearings 18 and 19 that support the input shaft 31 and the output shaft 12, thereby extending the life of the bearings 18 and 19. Moreover, since both the first bevel gear 13 and the fourth bevel gear 25 are located on the input shaft 31, centering of the first bevel gear 13 and the fourth bevel gear 25 can be easily conducted. Furthermore, as described in Embodiment 2, the positioning of the fourth bevel gear 25 in the radial direction and in the thrust direction can be conducted securely and accurately by means of the bearings 26, 27, 28 and 29.

An explanation is given below about the specific working of a machine tool equipped with the rotatory transmitting mechanism 3 according to Embodiment 3.

In order to transmit the rotatory motion from the input shaft 31 to the output shaft 12, as with Embodiment 1, the rotatory drive unit (not shown in the drawings) is first activated to rotate the input shaft 31 at a desired rotating speed. This rotation of the input shaft 31 causes the first bevel gear 13 to rotate. The second bevel gear 14 then engages with the first bevel gear 13. This results in transmitting the rotatory motion from the input shaft 31 to the second bevel gear 14. This action causes the rotatory motion from input shaft 31 to be transmitted through the second bevel gear 14 to output shaft 12, thereby causing output shaft 12 to rotate. Simultaneously, the second bevel gear 14 engages with the fourth bevel gear 25, thereby causing the fourth bevel gear 25 to rotate.

As described above, since transmitting parts 50 and 53 bear the load generated at the time of transmission of the rotatory motion from the input shaft 31 to the output shaft 12, the load is distributed as indicated by arrows in FIG. 6 at the time of transmission of the rotatory motion. Accordingly, it is possible to reduce the load on the bearings 18 and 19 that support the input shaft 31 and the output shaft 12. Moreover, the positioning of the fourth bevel gear 25 in the thrust direction and the radial direction can be conducted accurately and securely as described above.

The rotation of output shaft 12 causes the tool holder 100 to rotate, thereby enabling a tool (not shown in the drawings) mounted at the top of the tool holder 100 to perform the processing of a work piece.

(Embodiment 4)

A rotatory transmitting mechanism according to Embodiment 4 of this invention is described below with reference to the relevant drawings.

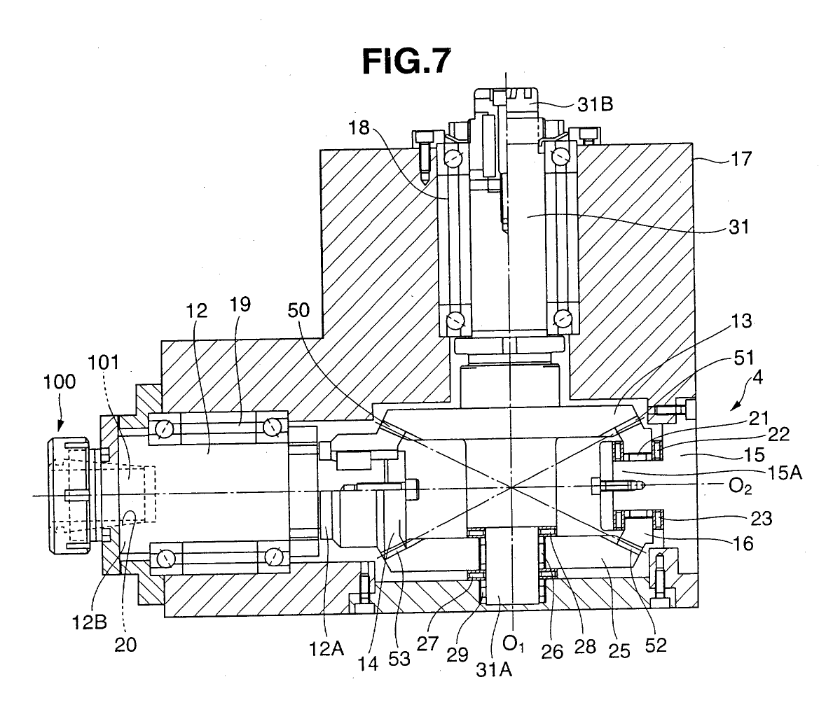

FIG. 7 is a sectional view of a part of a machine tool equipped with a rotatory transmitting mechanism according to Embodiment 4. Concerning Embodiment 4, elements similar to those described in the above-described embodiments are given the same reference numerals as in these embodiments, and any detailed explanation of such elements is omitted here.

As shown in FIG. 7, the main difference between a rotatory transmitting mechanism 4 of Embodiment 4 and the rotatory transmitting mechanism 3 of Embodiment 3 is that the third shaft 15 and the third bevel gear 16 are added to the construction of Embodiment 3.

For the rotatory transmitting mechanism 4 having the above-described construction, the fourth bevel gear 25 is positioned in a rotatable manner at one end 31A of input shaft 31 through bearings 26, 27, 28, and 29. Accordingly, centering of the first bevel gear 13 and the fourth bevel gear 25 can be more easily conducted. The detailed working of the rotatory transmitting mechanism 4 is similar to that of the rotatory transmitting mechanism 2.

(Embodiment 5)

A rotatory transmitting mechanism according to Embodiment 5 of this invention is described below with reference to the relevant drawings.

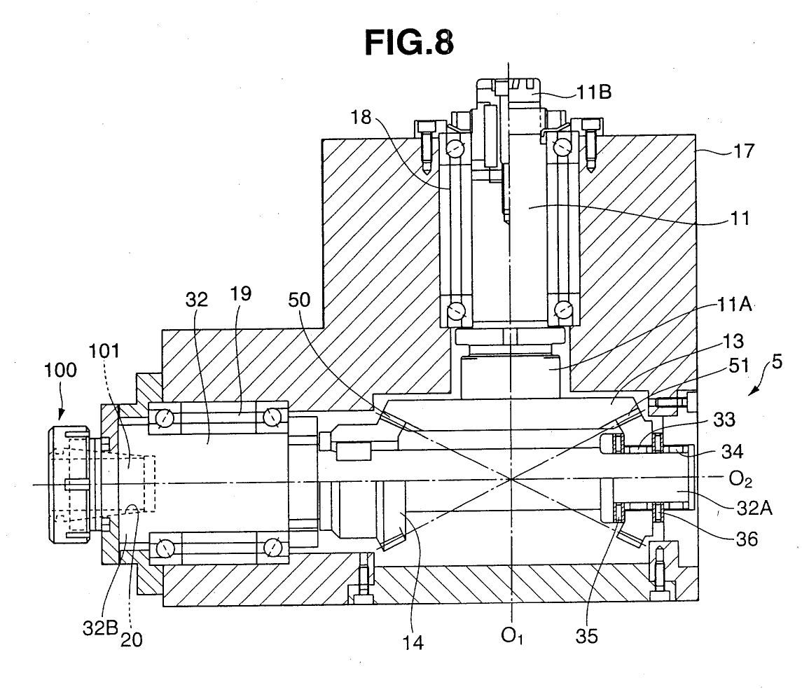

FIG. 8 is a sectional view of a part of a machine tool equipped with a rotatory transmitting mechanism according to Embodiment 5. For Embodiment 5, elements similar to those described in the above-described embodiments are given the same reference numerals as in these embodiments, and any detailed explanation of such elements is omitted here.

As shown in FIG. 8, the main difference between a rotatory transmitting mechanism 5 of Embodiment 5 and the rotatory transmitting mechanism 1 of Embodiment 1 is that, without providing the third shaft 15, an output shaft 32 extends beyond the second bevel gear 14, and the third bevel gear 16 is positioned in a rotatable manner at one end 32A of the output shaft 32.

The output shaft 32 is positioned in a rotatable manner in the housing 17 through bearing 19. At one end 32A of output shaft 32, the third bevel gear 16 is positioned in a rotatable manner through bearings 33, 34, 35, and 36. Examples of the bearings 33 and 34 include needle bearings, and the bearings 33 and 34 regulate the position of the third bevel gear 16 in the radial direction. Examples of the bearings 35 and 36 include thrust bearings, and the bearings 35 and 36 regulate the position of the third bevel gear 16 in the thrust direction. At a position closer to the other end 32B of the output shaft 32 and apart from the end 32A, the second bevel gear 14 is positioned in such a manner that it can rotate with the output shaft 32.

For the rotatory transmitting mechanism 5 having the above-described construction, the third bevel gear 16 is positioned in a rotatable manner at one end 32A of the output shaft 32 through the bearings 33, 34, 35, and 36. Accordingly, centering of the second bevel gear 14 and the third bevel gear 16 can be more easily conducted. The detailed working of the rotatory transmitting mechanism 5 is similar to that of the rotatory transmitting mechanism 1.

As another embodiment, the fourth shaft 24 and the fourth bevel gear 25 may be added to the construction of the rotatory transmitting mechanism 5. In this case, since the third bevel gear 16 is positioned in a rotatable manner at one end 32A of the output shaft 32 through bearings 33, 34, 35, and 36, centering of the second bevel gear 14 and the third bevel gear 16 can be more easily conducted. The detailed working of such embodiment is similar to that of the rotatory transmitting mechanism 2.

Embodiments 1 through 5 have been described above about the case where the transmitting parts 50, 51, 52, and 53 include the contacts where pairs of bevel gears engage with each other. However, the invention is not limited to this construction, and the transmitting parts may be constructed so as to transmit the rotatory motion, for example, by means of friction.

Moreover, Embodiments 1 through 5 have been described above about the case where the input shafts 11 or 31 and the output shafts 12 or 32 perpendicularly intersect with each other. However, the invention is not limited to this construction, and the two shafts may intersect with each other at any angle.

As described above, concerning the rotatory transmitting mechanism of this invention, the machine tool equipped with this rotatory transmitting mechanism, and the tool holder, the transmitting parts are located at symmetrical positions with respect to at least one of the shaft centers. Accordingly, it is possible to bear, at two positions at least, the load applied at the time of transmission of the rotatory motion. Therefore, it is possible to reduce the load on the bearings that support the shafts without the need for increasing the size of the rotatory transmitting mechanism, thereby extending the life of the bearings.

What is claimed is:

1. A rotatory transmitting mechanism comprising an input shaft and an output shaft, wherein the shaft centers of the input shaft and the output shaft intersect with each other, a rotatory motion between two shafts is transmitted, and transmitting parts are located at symmetrical positions with respect to at least one of the shaft centers.

2. The rotatory transmitting mechanism according to claim 1, wherein the transmitting parts located at the symmetrical positions are in the same configuration, respectively.

3. The rotatory transmitting mechanism according to claim 1 or 2, wherein the two shafts are an input shaft and an output shaft, whose shaft center intersects with the shaft center of the input shaft, and to which a rotatory motion from the input shaft is transmitted, and wherein the transmitting part located on the side of the shaft center of the input shaft opposite the output shaft side is mounted in a rotatable manner to a third shaft.

4. The rotatory transmitting mechanism according to claim 3, wherein the transmitting part located on the side of the shaft center of the output shaft opposite the input shaft side is mounted in a rotatable manner to a fourth shaft.

5. The rotatory transmitting mechanism according to claim 1 or 2, wherein the two shafts are an input shaft and an output shaft, whose shaft center intersects with the shaft center of the input shaft, and to which a rotatory motion from the input shaft is transmitted, and
wherein the transmitting part located on the side of the shaft center of the output shaft opposite the input shaft side is mounted in a rotatable manner to a fourth shaft.

6. The rotatory transmitting mechanism according to claim 1 or 2, wherein the two shafts are an input shaft and an output shaft, whose shaft center intersects with the shaft center of the input shaft, and to which a rotatory motion from the input shaft is transmitted, and
wherein one of the transmitting parts located at symmetrical positions with respect to the shaft center of the output shaft is located at one end of the input shaft, while the other transmitting part is located at a position closer to the other end of the input shaft and apart from the former transmitting part.

7. The rotatory transmitting mechanism according to claim 1, wherein the two shafts are an input shaft and an output shaft, whose shaft center intersects with the shaft center of the input shaft, and to which a rotatory motion from the input shaft is transmitted,
wherein the transmitting part located on the side of the shaft center of the input shaft opposite the output shaft side is mounted in a rotatable manner to a third shaft, and
wherein one of the transmitting parts located at symmetrical positions with respect to the shaft center of the output shaft is located at one end of the input shaft, while the other transmitting part is located at a position closer to the other end of the input shaft and apart from the former transmitting part.

8. The rotatory transmitting mechanism according to claim 1, wherein the transmitting parts located at the symmetrical positions are in the same configuration, respectively,
wherein the two shafts are an input shaft and an output shaft, whose shaft center intersects with the shaft center of the input shaft, and to which a rotatory motion from the input shaft is transmitted,
wherein the transmitting part located on the side of the shaft center of the input shaft opposite the output shaft side is mounted in a rotatable manner to a third shaft, and
wherein one of the transmitting parts located at symmetrical positions with respect to the shaft center of the output shaft is located at one end of the input shaft, while the other transmitting part is located at a position closer to the other end of the input shaft and apart from the former transmitting part.

9. The rotatory transmitting mechanism according to claim 1 or 2, wherein the two shafts are an input shaft and an output shaft, whose shaft center intersects with the shaft center of the input shaft, and to which a rotatory motion from the input shaft is transmitted, and
wherein one of the transmitting parts located at symmetrical positions with respect to the shaft center of the input shaft is located at one end of the output shaft, while the other transmitting part is located at a position closer to the other end of the output shaft and apart from the former transmitting part.

10. The rotatory transmitting mechanism according to claim 9, wherein the transmitting part located on the side of the shaft center of the output shaft opposite the input shaft side is mounted in a rotatable manner to a fourth shaft.

11. The rotatory transmitting mechanism according to claim 1, wherein the transmitting parts include a pair of gears that engages with each other.

12. The rotatory transmitting mechanism according to claim 1, wherein the transmitting parts transmit the rotatory motion by means of friction.

13. The rotatory transmitting mechanism according to claim 1, wherein the transmitting parts are supported by the bearings that regulate the positions of the transmitting parts in the thrust direction and in the radial direction.

14. The rotatory transmitting mechanism according to claim 1, wherein the two shafts perpendicularly intersect with each other.

15. A machine tool equipped with the rotatory transmitting mechanism stated in any one of claims 1 through 14.

16. A tool holder comprising:
the rotatory transmitting mechanism stated in any one of claims 1 through 14; and
a holder body with its one end connected to one end of the rotatory transmitting mechanism, and with the other end including a holding part for holding a tool.

17. A tool holder with its one end having a connection part connected to the machine tool according to claim 15, and with the other end including a holding part for holding a tool.
